(19) United States
(12) Patent Application Publication
(10) Pub. No.: US 2016/0331009 A1
(43) Pub. Date: Nov. 17, 2016

(54) Method of Making Snack Foods

(71) Applicant: FRITO-LAY TRADING COMPANY GMBH, Berne (CH)

(72) Inventors: John Richard BOWS, Leicestershire (GB); Richard Andrew BAILEY, Leicestershire (GB); Oliver HERBERT, Leicestershire (GB)

(21) Appl. No.: 15/110,866

(22) PCT Filed: Jan. 15, 2015
(86) PCT No.: PCT/EP2015/050713

§ 371 Date: Jul. 11, 2016

(30) Foreign Application Priority Data
Jan. 15, 2014 (GB) 1400658.9

(51) Int. Cl. A23L 19/18; A23L 5/10

(52) U.S. Cl. CPC A23L 19/18; A23L 5/15; A23V 2002/00

(57) ABSTRACT

Making snack foods by cooking a plurality of snack food slices disposed in a first layer having a first thickness to an average moisture content of from 10 to 20 wt. %, based on the total weight of the snack food slices. Then, stacking the cooked snack food slices as a packed bed having a second thickness which is greater than the first thickness. Next, microwave-drying the bed to reduce the moisture content to an average of from 6 to 8 wt. %, while maintaining the temperature of the bed lower than a glass transition temperature of starch in the snack food slices. Finish drying the snack food slices in a hot air dryer to reduce the moisture content of the snack food slices to an average of from 1 to 2 wt. %.

### CROSS-REFERENCE TO RELATED APPLICATIONS

This application is a US 371 National Stage Entry Application from PCT/EP2015/050713 filed Jan. 15, 2015, which claim priority to application GB1400658.9 filed Jan. 15, 2014 (now Publication GB2application GB1400658.9 filed Jan. 15, 2014 (now Publication GB2522198, published Jul. 22, 2015), the technical disclosures of which are hereby incorporated herein by reference.

### BACKGROUND OF THE INVENTION

1. Technical Field

The present invention relates to a method of making snack foods.

2. Description of Related Art

GB-A-2481272 discloses a method of manufacturing potato chips, in which potato slices are conveyed through a reservoir of oil in order to lipophilically condition the potato slices and thereafter the potato slices are conveyed through a flatbed microwave apparatus. The microwave apparatus is configured to define a plurality of successive independent microwave zones between the upstream and downstream ends of the microwave apparatus, each zone having a respective microwave attenuator at an upstream inlet and at a downstream outlet of the respective zone. The potato slices are preheated in a first preheating zone located towards an upstream end of the microwave apparatus. The first zone has a first microwave power value. The potato slices are explosively dehydrated in at least one second explosive dehydration zone located downstream of the first preheating zone. The explosive dehydration dries a body of the potato slices at a first drying rate. The second zone has a second microwave power value higher than the first microwave power value. The potato slices are then dried in a third drying microwave zone located downstream of the at least one second explosive dehydration zone.

This microwave-based production process can produce potato chips which have a light, crispy texture which is desired by consumers, and replaces a conventional frying process with a microwave explosive dehydration. The microwave explosive dehydration is controlled to achieve starch transitions which are correspondingly achieved in a fryer, so that texture is developed in the sliced potato during the microwave explosive dehydration which replicates the light, crispy texture achieved by a fryer.

The explosive dehydration is the texture development stage of the microwave process and is referred to as the primary microwave drying step. Potato slices enter the primary microwave stage at their original bulk moisture content, which is typically around 80 wt % moisture content on a wet basis. The potato slices are provided in a monolayer of singulated slices to prevent slices sticking together during the drying step and in order to improve microwave process stability. In order to generate a fried-like texture, the potato slices must be dried within a period of around 60 to 120 seconds to a final moisture content of typically from 10 to 20 wt % based on the total weight of the dried slices. The drying should be carried out below the glass transition temperature at the respective moisture content, which is a temperature of about 100 to 110° C.

After the texturizing step, it is necessary to dry the slice to a final moisture content of about 1.5 wt % based on the total weight of the slices.

For the further drying, it is necessary to ensure product quality as well as a cost-effective process.

By microwave drying food slices to an intermediate moisture content of around 10 to 20 wt %, a high degree of moisture variability may exist within the potato slices exiting the primary drying stage. A chip-to-chip moisture variability exists which is an inherent feature of rapid microwave drying. Such chip-to-chip moisture variability is affected by slice size and it has been found that slices have a diameter of below about 15 to 20 mm when employing a microwave operating frequency of 896 MHz tend to dry significantly slower than the larger slices. Furthermore, there may be intra-chip moisture variability. This is exhibited by the outer 1 to 4 mm of the edge of the food slice having a much higher moisture content than away from the slice edge, which is a characteristic feature of the rapid microwave drying of thin food slices.

The problem with such moisture variability is that edges of chips or the chips themselves have a moisture content higher than that required to set a light crispy texture during the glass transition step.

If further microwave drying of the monolayer is employed, to dry the product from a moisture content of 10 to 20 wt % to a final potato chip moisture content of about 1.5 wt %, when no free water is present at low moisture content the microwave energy would preferentially heat the starch/oil and the slice temperature would quickly rise to above 100° C. Also, the footprint required for monolayer drying is high, leading to high capital costs.

If the chips are dried from a moisture content of 10 to 20 wt % to a final potato chip moisture content of about 1.5 wt % in a conventional conductive oven, for example using heated air, employing chips of significant moisture variability can lead to various problems. In particular, parts of the chips would not have a rigid, set texture and there would be problems of the final chips exhibiting a glassy texture. There would be an increased risk of slices sticking together. In the final product there would be variable moisture content. There would be a risk of burning or scorching of the slices. In addition, the risk of acrylamide formation would be enhanced. In addition, the high temperature required in an oven for economically efficient drying, which is a temperature above 120° C., could lead to chips losing their crispy texture as a result of the starch moving back through the glassy state moisture transition, which is dependent on temperature.

Therefore, there exists a problem which is how to dry intermediate moisture content food slices, e.g. potato slices, in an economical process with such slices initially having a large moisture variability chip-to-chip and intra-chip (edge to centre) without losing a light crispy texture generated in a very high proportion of the slices.

### SUMMARY OF THE INVENTION

The present invention aims at least partially to solve that problem.

Accordingly, the present invention provides a method of making snack foods, the method comprising the steps of:
i. a cooking step comprising microwave cooking a plurality of snack food slices to provide cooked snack food slices having an average moisture content of from 10 to 20 wt % based on the total weight of the snack food slices, the plurality of snack food slices being disposed in a layer having a first thickness during the microwave cooking;
ii. a stacking step of disposing the cooked snack food slices as a loosely packed bed having a second thickness of from 5 to 20 mm which is greater than the first thickness;
iii. a drying step comprising applying multimode microwave energy to the bed for a period of from 30 to 180 seconds to reduce the moisture content of the dried snack food slices to an average of from 6 to 8 wt % based on the total weight of the snack food slices while maintaining the temperature of the bed to a value below 100° C. which is lower than a glass transition temperature of starch in the snack food slices; and
iv. finish drying the snack food slices in a hot air dryer to reduce the moisture content of the snack food slices to an average of from 1 to 2 wt % based on the total weight of the snack food slices.

Preferred features are defined in the dependent claims.

The present invention is predicated on the finding by the present inventors that since most of the food slices exiting the primary microwave dryer in the cooking step are typically free of surface water, and typically with their texture and shape set, the slices can be “deep bedded” for a short period, for example from 1 to 2 minutes, as they enter a second stage microwave dryer without any risk of the slices sticking or clumping together. A deep bed microwave multimode cavity has been chosen to solve the problem, because deep bedding the food slices is economically advantaged by minimising the footprint required to dry a large volume of food slices.

Furthermore, since the microwave energy self-seeks a higher moisture content region in food slices where most of the food slices have little free water present, the higher moisture content slices and higher moisture content slice edges can be rapidly dried to below the glass transition moisture content. The drying remains in a much lower temperature range than in a traditional hot air dryer, thus reducing the risk of starch retrogradation, which is exhibited as a loss of a crispy state as the starch moves back to the glassy state moisture transition.

By selecting the specific moisture content range exiting the primary microwave drier, a secondary deep bed microwave dryer can self-seek higher moisture content regions and higher moisture parts of potato slices which would otherwise risk sticking to other slices. By providing a selected initial moisture content range for the slices exiting the microwave cooking and entering the drying step, the microwave technology can readily be employed to achieve moisture levelling of the cooked food slices. The deep bed drying can overcome the initial high degree of moisture variability within the plurality of slices exiting the primary drying stage, in particular chip-to-chip moisture variability and intra-chip moisture variability, to provide, with a final finish-drying stage, a high quality uniformly dried food product with a typical final moisture content of about 1.5 wt %.

### BRIEF DESCRIPTION OF THE DRAWINGS

Embodiments of the present invention will now be described by way of example only, with reference to the accompanying drawings, in which:

FIG. 1 is a schematic diagram of a process flow of steps carried out in a method of making snack foods in accordance with an embodiment of the present invention.

### DETAILED DESCRIPTION OF THE INVENTION

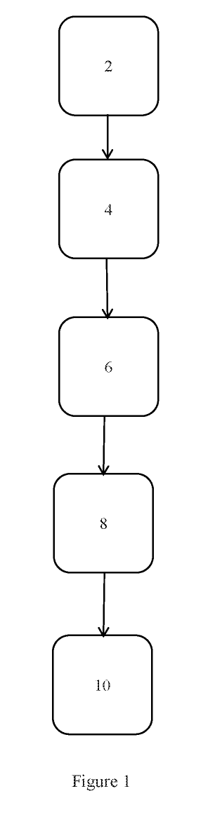

Referring to FIG. 1, a method of making snack foods in accordance with an embodiment of the present invention is illustrated as a process flow of steps.

In this embodiment the snack foods comprise potato chips produced from potato slices. However, the method of the invention may be used to make other snack foods from other starting ingredients. For example, slices of vegetables other than potato may be used, for example carrot, parsnip, beetroot, etc. The slices may be composed of a dough, which may contain vegetable matter in the form of fresh vegetable, dry vegetable or powdered vegetable, or any combination thereof.

In this embodiment, initially the plurality of potato slices is subjected to a lipophilically conditioning step 2. The snack food slices are immersed in a vegetable oil at a temperature of from 80° C. to less than 100° C., optionally about 90° C., for a period of from 60 to 120 seconds, optionally about 90 seconds.

Thereafter, the lipophilically conditioned snack food slices are subjected to a microwave cooking step 4. In the cooking step 4 the microwave energy typically has a frequency of from 875 to 925 MHz, optionally about 900 MHz, or 2450+/−50 MHz.

In the cooking step 4 the plurality of snack food slices are disposed in a monolayer with substantially all, optionally at least 80%, of the snack food slices being free from contact with any other snack food slice. During the microwave cooking, the plurality of snack food slices is disposed in a layer having a thickness of from 1 to less than 5 mm, optionally from 1 to 3 mm.

Prior to the cooking step 4, the moisture content of the snack food slices is typically an average value of at least 75 wt %%, optionally about 80 wt %, based on the total weight of the snack food slices. During the cooking step 4 the moisture content of the snack food slices is reduced. The cooking step 4 comprises microwave cooking the plurality of snack food slices to provide cooked snack food slices having an average moisture content of from 10 to 20 wt % based on the total weight of the snack food slices.

During the cooking step 4 the moisture content of the snack food slices is reduced within a period of from 30 to 180 seconds, optionally from 60 to 120 seconds.

During the cooking step 4 the temperature of the snack food slices is maintained below 110° C., optionally below 100° C.

After the cooking step 4 the cooked snack food slices are substantially rigid and typically have substantially randomly shaped non-planar opposite major surfaces. The cooked snack food slices are substantially free of surface water.

After the cooking step 4, there is a stacking step 6. In the stacking step the cooked snack food slices are disposed as a loosely packed bed having a thickness greater than the thickness of the layer of slices during the cooking step. The bed thickness is from 5 to 200 mm, optionally from 5 to 75 mm. Preferably, the loosely packed bed comprises from 30 to 80 vol % air based on the total volume of the bed.

In the stacking step 6 the cooked snack food slices are conveyed by a vibratory conveyor which increases the packing density and commonality of orientation of the cooked snack food slices in the loosely packed bed. The bed of snack food slices preferably comprises a plurality of sub-layers of the snack food slices, and preferably in each sub-layer the snack food slices are substantially commonly oriented. Optionally, in each sub-layer the snack food slices are oriented within an angle of +/−30 degrees to the horizontal.

After the stacking step 6, a drying step 8 is carried out on the loosely packed bed. The drying step 8 comprises applying multimode microwave energy to the bed to reduce the moisture content of the dried snack food slices to an average of from 6 to 8 wt %, based on the total weight of the snack food slices, while maintaining the temperature of the bed to a value lower than a glass transition temperature of starch in the snack food slices. In particular, the temperature of the bed is maintained below 100° C.

The drying step 8 is carried out for a period of from 30 to 180 seconds, optionally from 60 to 120 seconds.

The drying step 8 can preferably provide a moisture content of the dried snack food slices which has a smaller standard deviation than the moisture content of the cooked snack food slices provided by cooking step 4.

After the drying step 8 preferably substantially all, optionally at least 99 wt %, of the snack food slices each have a moisture content within the range of from 6 to 8 wt % based on the total weight of the snack food slice.

In the drying step 8 the microwave energy typically has a frequency of from 875 to 925 MHz, optionally about 900 MHz, or 2450+/−50 MHz. The microwave frequency in both the cooking and drying steps 4, 8 may be the same.

After the drying step 8, the snack food slices are subjected to finish drying 10 in a hot air dryer to reduce the moisture content of the snack food slices to an average of from 1 to 2 wt % based on the total weight of the snack food slices. In the finish drying step 10, the hot air from the hot air dryer is typically at a temperature of greater than 100° C., optionally greater than 120° C.

Various modifications to the method of the invention as described herein will be apparent to those skilled in the art.

1. A method of making snack foods, the method comprising the following steps:
i. a cooking step comprising microwave cooking a plurality of snack food slices to provide cooked snack food slices having an average moisture content of from 10 to 20 wt % based on the total weight of the snack food slices, the plurality of snack food slices being disposed in a layer having a first thickness during the microwave cooking;
ii. a stacking step of disposing the cooked snack food slices as a loosely packed bed having a second thickness of from 5 to 20 mm which is greater than the first thickness;
iii. a drying step comprising applying multimode microwave energy to the bed for a period of from 30 to 180 seconds to reduce the moisture content of the dried snack food slices to an average of from 6 to 8 wt % based on the total weight of the snack food slices while maintaining the temperature of the bed to a value below 100° C. which is lower than a glass transition temperature of starch in the snack food slices; and
iv. a finish drying step including drying the snack food slices in a hot air dryer to reduce the moisture content of the snack food slices to an average of from 1 to 2 wt % based on the total weight of the snack food slices.

2. A method according to claim 1, wherein the drying step iii provides a moisture content of the dried snack food slices which has a smaller standard deviation than the moisture content of the cooked snack food slices provided by cooking step i.

3. A method according to claim 1, wherein the drying step iii is carried out for a period of from 60 to 120 seconds.

4. A method according to claim 1, wherein the second thickness is from 5 to 75 mm.

5. A method according to claim 1 wherein after the drying step iii substantially all, optionally at least 99 wt %, of the snack food slices each have a moisture content within the range of from 6 to 8 wt % based on the total weight of the snack food slice.

6. A method according to claim 1 wherein in the cooking step i the plurality of snack food slices are disposed in a monolayer with substantially all, optionally at least 80%, of the snack food slices being free from contact with any other snack food slice.

7. A method according to claim 1 wherein in the drying step iii the bed of snack food slices comprises a plurality of sub-layers of the snack food slices.

8. A method according to claim 7, wherein in each sub-layer the snack food slices are substantially commonly oriented

9. A method according to claim 8, wherein in each sub-layer the snack food slices are oriented within an angle of +/−30 degrees to the horizontal.

10. A method according to claim 1 wherein in stacking step ii the cooked snack food slices are conveyed by a vibratory conveyor which increases the packing density and commonality of orientation of the cooked snack food slices in the loosely packed bed.

11. A method according to any foregoing claim 1, wherein the loosely packed bed comprises from 30 to 80 vol % air based on the total volume of the bed.

12. A method according to claim 1, wherein the first thickness is from 1 to less than 5 mm, optionally from 1 to 3 mm.

13. A method according to claim 1 wherein in the cooking step i the moisture content of the snack food slices is reduced from an average value of at least 75 wt %, optionally about 80 wt %, based on the total weight of the snack food slices to the average moisture content of from 10 to 20 wt %, based on the total weight of the snack food slices.

14. A method according to claim 13, wherein in the cooking step i the moisture content of the snack food slices is reduced within a period of from 30 to 180 seconds.

15. A method according to claim 1 wherein in the cooking step i the temperature of the snack food slices is maintained below 110° C.

16. A method according to claim 1 wherein after the cooking step i the cooked snack food slices are substantially rigid.

17. A method according to claim 1 wherein after the cooking step i the cooked snack food slices are substantially free of surface water.

18. A method according to claim 1 wherein in at least one or both of the cooking step i and the drying step iii the microwave energy has a frequency of from 875 to 925 MHz.

19. A method according to claim 1 wherein in the finish drying step iv the hot air from the hot air dryer is at a temperature of greater than 100° C.

20. A method according to claim 1, further comprising the step, before step i, of lipophilically conditioning the snack food slices by immersion in a vegetable oil at a temperature of from 80° C. to less than 100° C.

21. A method according to claim 1, wherein the snack food slices are potato slices and the snack foods comprise potato chips.
